(19) United States
(12) Patent Application Publication
(10) Pub. No.: US 2021/0385078 A1
(43) Pub. Date: Dec. 9, 2021

(54) PHASE DECODING METHOD AND APPARATUS FOR QUANTUM KEY DISTRIBUTION, AND CORRESPONDING SYSTEM

(71) Applicant: CHINA ACADEMY OF ELECTRONICS AND INFORMATION TECHNOLOGY OF CETC, Beijing (CN)

(72) Inventors: Huaxing XU, Beijing (CN); Changlei WANG, Beijing (CN); Ping ZHANG, Beijing (CN)

(21) Appl. No.: 17/289,127

(22) PCT Filed: Oct. 28, 2019
(86) PCT No.: PCT/CN2019/113713

§ 371 Date: Apr. 27, 2021

(30) Foreign Application Priority Data
Oct. 29, 2018 (CN) 201811264206.X

(51) Int. Cl. H04L 9/08; H04B 10/548; G06N 10/00

(52) U.S. Cl. CPC H04L 9/0858; H04B 10/548; G02B 6/29349; G06N 10/00; H04L 9/0819

(57) ABSTRACT

A phase decoding method and apparatus for quantum key distribution based on reflection with an orthogonal rotation of polarization, and a corresponding system. The method comprises: splitting an input optical pulse of an arbitrary polarization state into two optical pulses by a beam splitter; and, transmitting the two optical pulses respectively along two optical paths, with a relative time delay applied to them, and then reflecting them back to the beam splitter respectively by two reflecting devices to be combined and output by the beam splitter. A phase modulation is performed on at least one of the two optical pulses according to a quantum key distribution protocol, and two orthogonal polarization states of the optical pulse are reflected with an orthogonal rotation of polarization, so that each orthogonal polarization state of the optical pulse, after being reflected by the corresponding reflecting device, is transformed to a polarization state orthogonal thereto.

### CROSS-REFERENCE TO RELATED APPLICATIONS

This application is a national application of PCT/CN2019/113713, filed on Oct. 28, 2019 and claiming priority to the following application: Chinese Patent Application No. 201811264206X filed on Oct. 29, 2018, which is incorporated herein by reference in its entirety.

### FIELD OF THE INVENTION

The present invention relates to the field of secure communication technologies using optical transmission, and in particular, to a phase decoding method and apparatus for quantum key distribution based on reflection with an orthogonal rotation of polarization, and a quantum key distribution system comprising the apparatus.

### BACKGROUND

Quantum secure communication technologies are a frontier hotspot field combining quantum physics with information science. Based on the quantum key distribution technology and the principle of one-time pad, quantum secure communication can realize secure transmission of information in public channels. Quantum key distribution, which is based on physical principles such as the Heisenberg uncertainty relationship of quantum mechanics, and quantum no-cloning theorem, can realize safe sharing of keys among users and detect potential eavesdropping behaviors, and can be applied in the fields of national defense, government affairs, finance, electric power and the like with high needs for secure information transmission.

At present, encoding schemes for quantum key distribution mainly adopt polarization encoding and phase encoding. Ground quantum key distribution is mainly based on optical fiber channel transmission; however, for fabrication of an optical fiber, there exist non-ideal conditions such as non-circular symmetry of the cross-section and uneven distribution of the fiber core's refractive index in the radial direction, and in the actual environment, an optical fiber is affected by temperature, strain, bending, etc., which will cause random birefringence effect. Where polarization encoding is used, due to the effect of random birefringence of an optical fiber, when a polarization-encoded quantum state reaches a receiving end after being transmitted via a long-distance optical fiber, a polarization state of the optical pulse will change randomly, resulting in an increased bit error rate and leading to a need to add a polarization correcting device, which increases the system's complexity and cost, and it is difficult to achieve stable use in situations with strong interference, such as those for overhead optical cables and road and bridge optical cables. As compared with polarization encoding, phase encoding uses a phase difference between a previous optical pulse and a next optical pulse to encode information and can be kept stable during long-distance optical fiber channel transmission. However, for a phase encoding scheme, due to the effect of birefringence of a transmission optical fiber and a codec interferometer's optical fibers, there is a problem of polarization-induced fading in performing interference for decoding purpose, which leads to unstable decoding interference. Likewise, if a polarization correcting device is added, although correction of polarization needs to be performed on only one polarization state, the system's complexity and cost will also increase. For a phase encoding scheme for quantum key distribution, how to perform interference for decoding purpose stably and efficiently is a hotspot and difficult problem for quantum secure communication applications based on the existing optical cable infrastructure.

### SUMMARY OF THE INVENTION

The main purpose of the present invention is to propose a phase decoding method and apparatus for quantum key distribution based on reflection with an orthogonal rotation of polarization, so as to solve the problem of interference for phase decoding purpose being instable due to polarization-induced fading in phase encoding quantum key distribution applications.

The present invention provides at least the following technical solutions:

1. A phase decoding method for quantum key distribution based on reflection with an orthogonal rotation of polarization, wherein the method comprises:

splitting one input optical pulse of an arbitrary polarization state into two optical pulses by a beam splitter; and

transmitting the two optical pulses respectively along two optical paths, with a relative time delay applied to the two optical pulses, and then reflecting them back to the beam splitter respectively by two reflecting devices to be combined and output by the beam splitter;

wherein a phase modulation is performed on at least one of the two optical pulses according to a quantum key distribution protocol in a process of beam splitting by the beam splitter to beam combining by the beam splitter, and

wherein for each of the two optical pulses:

when the optical pulse is reflected by a corresponding reflecting device of the two reflecting devices, two orthogonal polarization states of the optical pulse are reflected with an orthogonal rotation of polarization, so that each orthogonal polarization state of the optical pulse, after being reflected by the corresponding reflecting device, is transformed to a polarization state orthogonal thereto.

2. The phase decoding method for quantum key distribution based on reflection with an orthogonal rotation of polarization according to solution 1, wherein the two reflecting devices are reflecting devices with an orthogonal rotation of circular polarization, and each of the two reflecting devices comprises a reflecting mirror.

3. The phase decoding method for quantum key distribution based on reflection with an orthogonal rotation of polarization according to solution 2, wherein the beam splitter is a circular polarization maintaining beam splitter.

4. The phase decoding method for quantum key distribution based on reflection with an orthogonal rotation of polarization according to solution 1, wherein the two reflecting devices are reflecting devices with an orthogonal rotation of linear polarization.

5. The phase decoding method for quantum key distribution based on reflection with an orthogonal rotation of polarization according to solution 4, wherein each of the two reflecting devices comprises a reflecting mirror and a quarter-wave plate, and the reflecting mirror is integrally formed with the quarter-wave plate at a rear end of the quarter-wave plate, wherein an included angle between a polarization direction of one of the two orthogonal polarization states of each of the two optical pulses and a slow axis of the quarter-wave plate is 45 degrees.

6. The phase decoding method for quantum key distribution based on reflection with an orthogonal rotation of polarization according to solution 4, wherein the beam splitter is a linear polarization maintaining beam splitter.

7. The phase decoding method for quantum key distribution based on reflection with an orthogonal rotation of polarization according to solution 1, wherein the two reflecting devices are reflecting devices with an orthogonal rotation of elliptical polarization.

8. The phase decoding method for quantum key distribution based on reflection with an orthogonal rotation of polarization according to solution 7, wherein the beam splitter is an elliptical polarization maintaining beam splitter.

9. The phase decoding method for quantum key distribution based on reflection with an orthogonal rotation of polarization according to solution 1, wherein for each of the two optical pulses:

the two orthogonal polarization states of the optical pulse are kept unchanged during the beam splitting by the beam splitter to reflecting by the corresponding reflecting device, and kept unchanged during the reflecting by the corresponding reflecting device to the beam combining by the beam splitter.

10. A phase decoding apparatus for quantum key distribution based on reflection with an orthogonal rotation of polarization, wherein the phase decoding apparatus comprises: a beam splitter, two reflecting devices, and two optical paths that are optically coupled with the beam splitter and respectively optically coupled with the two reflecting devices, wherein there is a phase modulator on at least one of the two optical paths,

the beam splitter being used for splitting one input optical pulse of an arbitrary polarization state into two optical pulses;

the two optical paths being used for respectively transmitting the two optical pulses, and being used for realizing a relative time delay of the two optical pulses;

the two reflecting devices being used for respectively reflecting the two optical pulses transmitted by the two optical paths from the beam splitter back to the beam splitter to be combined and output by the beam splitter; and

the phase modulator being used for performing a phase modulation on an optical pulse transmitted by an optical path on which it is located according to a quantum key distribution protocol,

wherein the two reflecting devices are structured so that, for each of the two optical pulses:

when the optical pulse is reflected by a corresponding reflecting device of the two reflecting devices, two orthogonal polarization states of the optical pulse are reflected with an orthogonal rotation of polarization, so that each orthogonal polarization state of the optical pulse, after being reflected by the corresponding reflecting device, is transformed to a polarization state orthogonal thereto.

11. The phase decoding apparatus for quantum key distribution based on reflection with an orthogonal rotation of polarization according to solution 10, wherein the two reflecting devices are reflecting devices with an orthogonal rotation of circular polarization, and each of the two reflecting devices comprises a reflecting mirror.

12. The phase decoding apparatus for quantum key distribution based on reflection with an orthogonal rotation of polarization according to solution 11, wherein the beam splitter is a circular polarization maintaining beam splitter.

13. The phase decoding apparatus for quantum key distribution based on reflection with an orthogonal rotation of polarization according to solution 10, wherein the two reflecting devices are reflecting devices with an orthogonal rotation of linear polarization.

14. The phase decoding apparatus for quantum key distribution based on reflection with an orthogonal rotation of polarization according to solution 13, wherein each of the two reflecting devices comprises a reflecting mirror and a quarter-wave plate, and the reflecting mirror is integrally formed with the quarter-wave plate at a rear end of the quarter-wave plate, wherein the quarter-wave plate is structured so that an included angle between a polarization direction of one of the two orthogonal polarization states of each of the two optical pulses and a slow axis of the quarter-wave plate is 45 degrees.

15. The phase decoding apparatus for quantum key distribution based on reflection with an orthogonal rotation of polarization according to solution 13, wherein the beam splitter is a linear polarization maintaining beam splitter.

16. The phase decoding apparatus for quantum key distribution based on reflection with an orthogonal rotation of polarization according to solution 10, wherein the two reflecting devices are reflecting devices with an orthogonal rotation of elliptical polarization.

17. The phase decoding apparatus for quantum key distribution based on reflection with an orthogonal rotation of polarization according to solution 16, wherein the beam splitter is an elliptical polarization maintaining beam splitter.

18. The phase decoding apparatus for quantum key distribution based on reflection with an orthogonal rotation of polarization according to solution 10, wherein the two optical paths are polarization maintaining optical paths.

19. A quantum key distribution system, comprising:

the phase decoding apparatus for quantum key distribution based on reflection with an orthogonal rotation of polarization according to solution 10, provided on a receiving end of the quantum key distribution system for phase decoding.

Through a creative configuration, the present invention uses reflection with an orthogonal rotation of polarization to control a phase difference of each of two orthogonal polarization states of an input optical pulse as a result of being transmitted by two arms of a decoding interferometer to be equal, so that the two orthogonal polarization states of the input optical pulse of an arbitrary polarization state can interfere and be output stably, thereby achieving unexpected beneficial effect. With the solution of the present invention, for an input optical pulse of an arbitrary polarization state, stable interference and output at the decoding interferometer can be realized, and the problem that the system cannot work stably due to polarization-induced fading in phase encoding quantum key distribution applications is solved. The present invention provides a decoding scheme for phase encoding quantum key distribution that is easy to implement and apply and resists polarization-induced fading.

### BRIEF DESCRIPTION OF THE DRAWINGS

FIG. 1 is a flowchart of a phase decoding method for quantum key distribution based on reflection with an orthogonal rotation of polarization of a preferred embodiment of the present invention;

FIG. 2 is a schematic diagram of composition and structure of a phase decoding apparatus for quantum key distribution based on reflection with an orthogonal rotation of polarization of a preferred embodiment of the present invention;

FIG. 3 is a schematic diagram of composition and structure of a phase decoding apparatus for quantum key distribution based on reflection with an orthogonal rotation of polarization of another preferred embodiment of the present invention; and

FIG. 4 is a schematic diagram of composition and structure of a phase decoding apparatus for quantum key distribution based on reflection with an orthogonal rotation of polarization of another preferred embodiment of the present invention.

### DETAILED DESCRIPTION OF THE EMBODIMENTS

In the following, preferred embodiments of the present invention are described in detail in conjunction with the accompanying figures, which form a part of the present application and are used together with the embodiments of the present invention to set forth the principle of the present invention. For clarity and simplification, a detailed concrete description of the known function and structure of the devices described herein will be omitted, when it may obscure the subject matter of the present invention.

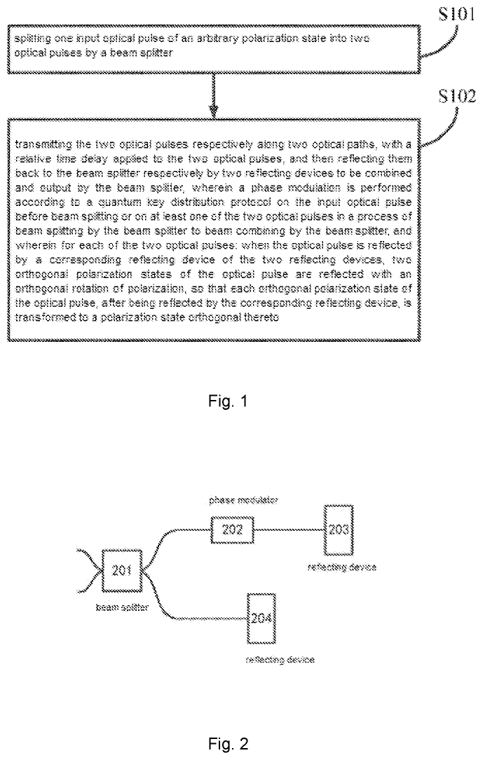

A phase decoding method for quantum key distribution based on reflection with an orthogonal rotation of polarization of a preferred embodiment of the present invention is as shown in FIG. 1, and comprises the following steps.

Step S101 is splitting one input optical pulse of an arbitrary polarization state into two optical pulses by a beam splitter.

An incident input optical pulse is of an arbitrary polarization state, and may be completely polarized light which is linearly polarized, circularly polarized, or elliptically polarized, or may also be partially polarized light or unpolarized light.

The incident input optical pulse may be regarded as being composed of two orthogonal polarization states. Naturally, the two optical pulses obtained by beam splitting may also be likewise regarded as being composed of two orthogonal polarization states that are the same as those of the incident input optical pulse.

The beam splitter may be a 50:50 optical fiber coupler, which splits one incident input optical pulse into two optical pulses at a ratio of 50:50.

Step S102 is transmitting the two optical pulses obtained by beam splitting respectively along two optical paths, with a relative time delay applied to these two optical pulses, and then reflecting them back to the beam splitter respectively by two reflecting devices to be combined and output by the beam splitter.

In the method, the two optical pulses are reflected an odd number of times respectively by the two reflecting devices or are reflected an even number of times (including zero times, i.e., being directly transmitted) respectively by the two reflecting devices, and then combined and output by the beam splitter.

In the method, a phase modulation may be performed according to a quantum key distribution protocol on the input optical pulse before beam splitting or on at least one of the two optical pulses in a process of beam splitting by the beam splitter to beam combining by the beam splitter.

Here, the relative time delay and the phase modulation are performed according to the requirements and regulations of the quantum key distribution protocol, which is not described in detail herein.

According to the method of the present invention, for each of the two optical pulses obtained by beam splitting: when the optical pulse is reflected by a corresponding reflecting device of the two reflecting devices, two orthogonal polarization states of the optical pulse are reflected with an orthogonal rotation of polarization, so that each orthogonal polarization state of the optical pulse, after being reflected by the corresponding reflecting device, is transformed to a polarization state orthogonal thereto.

For example, assuming that the two orthogonal polarization states are x polarization state and y polarization state respectively, the x polarization state transmitted along an optical path to a reflecting device, after undergoing reflection with an orthogonal rotation of polarization at the reflecting device, is transformed into a polarization state which is orthogonal to it, i.e., the y polarization state, and the y polarization state transmitted along the optical path to the reflecting device, after undergoing reflection with an orthogonal rotation of polarization at the reflecting device, is transformed into a polarization state which is orthogonal to it, i.e., the x polarization state.

In this way, using the reflection with an orthogonal rotation of polarization at the reflecting device, a phase difference of the x polarization state of the input optical pulse as a result of being transmitted by the two optical paths in the process of beam splitting by the beam splitter to beam combining by the beam splitter is exactly equal to a phase difference of the y polarization state of the optical pulse as a result of being transmitted by the two optical paths in the process of beam splitting by the beam splitter to beam combining by the beam splitter.

According to a possible configuration, the above two reflecting devices are reflecting devices with an orthogonal rotation of circular polarization. For example, each of the above two reflecting devices comprises a reflecting mirror. In this case, the above beam splitter may be a circular polarization maintaining beam splitter. Here, a reflecting device with an orthogonal rotation of circular polarization refers to a reflecting device that can perform reflection with an orthogonal rotation of polarization on an incident light of a circular polarization state, that is, that when reflecting the incident light of a circular polarization state, transforms a polarization state of the light of a circular polarization state to a polarization state orthogonal thereto, that is, an incident left-handed circularly polarized light, after being reflected by the reflecting device with an orthogonal rotation of circular polarization, is transformed to a right-handed circularly polarized light orthogonal thereto, and an incident right-handed circularly polarized light, after being reflected by the reflecting device with an orthogonal rotation of circular polarization, is transformed to a left-handed circularly polarized light orthogonal thereto.

According to another possible configuration, the above two reflecting devices are reflecting devices with an orthogonal rotation of linear polarization. For example, each of the above two reflecting devices comprises a reflecting mirror and a quarter-wave plate, and the reflecting mirror is integrally formed with the quarter-wave plate at a rear end of the quarter-wave plate, wherein an included angle between a polarization direction of one of the two orthogonal polarization states of each of the two optical pulses and a fast axis or a slow axis of the quarter-wave plate is 45 degrees. In this case, the above beam splitter may be a linear polarization maintaining beam splitter. Such a reflecting device including a reflecting mirror and a quarter-wave plate may be referred to as a “reflecting mirror with a quarter-wave plate” for short, and may be realized by plating a reflecting mirror on a crystal surface of a quarter-wave plate, or by plating a reflecting mirror on an end surface of a polarization maintaining optical fiber with a 90-degree difference in phase of transmission between fast and slow axes. Here, a reflecting device with an orthogonal rotation of linear polarization refers to a reflecting device that can perform reflection with an orthogonal rotation of polarization on an incident light of a linear polarization state, that is, that when reflecting the incident light of a linear polarization state, transforms a polarization state of the light of a linear polarization state to a polarization state orthogonal thereto, that is, an incident x linearly polarized light, after being reflected by the reflecting device with an orthogonal rotation of linear polarization, is transformed to a y linearly polarized light orthogonal thereto, and an incident y linearly polarized light, after being reflected by the reflecting device with an orthogonal rotation of linear polarization, is transformed to a x linearly polarized light orthogonal thereto.

According to yet another possible configuration, the above two reflecting devices are reflecting devices with an orthogonal rotation of elliptical polarization, and the above beam splitter may be an elliptical polarization maintaining beam splitter. In this case, suitable reflecting devices may be selected based on a specific elliptical polarization maintaining beam splitter. Here, a reflecting device with an orthogonal rotation of elliptical polarization refers to a reflecting device that can perform reflection with an orthogonal rotation of polarization on an incident light of an elliptical polarization state, that is, that when reflecting the incident light of an elliptical polarization state, transforms a polarization state of the light of an elliptical polarization state to a polarization state orthogonal thereto, that is, an incident left-handed elliptically polarized light, after being reflected by the reflecting device with an orthogonal rotation of elliptical polarization, is transformed to a right-handed elliptically polarized light orthogonal thereto, and an incident right-handed elliptically polarized light, after being reflected by the reflecting device with an orthogonal rotation of elliptical polarization, is transformed to a left-handed elliptically polarized light orthogonal thereto.

For the above several configurations, advantageously, for each of the two optical pulses obtained by beam splitting: the two orthogonal polarization states of the optical pulse are kept unchanged during the beam splitting by the beam splitter to reflecting by the corresponding reflecting device, and kept unchanged during the reflecting by the corresponding reflecting device to the beam combining by the beam splitter. This may be realized, for example, by configuring the two optical paths as polarization maintaining optical paths and configuring optical devices on the two optical paths as polarization maintaining optical devices and/or non-birefringent optical devices.

A phase decoding apparatus for quantum key distribution based on reflection with an orthogonal rotation of polarization of a preferred embodiment of the present invention is as shown in FIG. 2, and comprises the following components: a beam splitter 201, a phase modulator 202, and two reflecting devices 203 and 204.

The beam splitter 201 is optically coupled to the two reflecting devices 203 and 204 via two optical paths, respectively. The phase modulator 202 is configured on one of the two optical paths. Each of the reflecting devices 203 and 204 is a reflecting device with an orthogonal rotation of polarization.

Here, a reflecting device with an orthogonal rotation of polarization refers to a reflecting device that can perform reflection with an orthogonal rotation of polarization on two orthogonal polarization states of an optical pulse that it reflects, that is, that when reflecting an incident optical pulse, transforms each orthogonal polarization state of the optical pulse to a polarization state orthogonal thereto.

The beam splitter 201 is used for splitting one incident input optical pulse into two optical pulses to transmit them respectively along the two optical paths.

The two optical paths are used for respectively transmitting the two optical pulses, and are used for realizing a relative time delay of the two optical pulses.

The phase modulator 202 is used for performing a phase modulation on an optical pulse transmitted by an optical path on which it is located (i.e., one of the two optical pulses) according to a quantum key distribution protocol. The phase modulator 202 may randomly modulate a 0 degree phase or a 90 degree phase.

The phase modulator 202 may be a polarization independent phase modulator or a polarization dependent phase modulator.

A polarization independent phase modulator is suitable for performing the same phase modulation on two orthogonal polarization states of an optical pulse, so it is called polarization independent. For example, the polarization independent phase modulator may be realized by two birefringent phase modulators in series or in parallel. According to the situation, the phase modulation may be realized by a variety of specific means. For example, these means may comprise: modulating a length of a free space optical path, or modulating a length of an optical fiber, or using an optical waveguide phase modulator that is in series or in parallel, etc. For example, the desired phase modulation may be realized by changing the length of the free space optical path with a motor. As another example, the length of the optical fiber may be modulated by an optical fiber stretcher using piezoelectric effect, thereby realizing the phase modulation. In addition, the phase modulator may be of other types suitable for being controlled by a voltage, and the desired phase modulation may be realized by applying an appropriate voltage to the polarization independent phase modulator to perform the same phase modulation on the two orthogonal polarization states of the optical pulse.

A polarization dependent phase modulator, for example, a birefringent phase modulator, is suitable for applying different adjustable phase modulation to two orthogonal polarization states passing through it. For example, the birefringent phase modulator may be a lithium niobate phase modulator, and by controlling a voltage applied to the lithium niobate crystal, may control and adjust the phase modulation undergone by each of the two orthogonal polarization states passing through the lithium niobate phase modulator.

Although in FIG. 2 only one phase modulator 202 is shown as being provided on one of the two optical paths, it is also possible to configure one phase modulator on each of the two optical paths. In the case of two phase modulators being provided in this way, a difference between phases modulated by the two phase modulators is determined by the quantum key distribution protocol. In addition, instead of providing phase modulator(s) on one or both of the two optical paths, a phase modulator can be provided before the beam splitter 201 for performing a phase modulation on the input optical pulse before beam splitting according to the quantum key distribution protocol.

The reflecting devices 203 and 204 are respectively used for reflecting the two optical pulses transmitted by the two optical paths from the beam splitter 201 back to the beam splitter 201 to be combined and output by the beam splitter 201.

Since the two reflecting devices 203 and 204 are both reflecting devices with an orthogonal rotation of polarization, for each of the two optical pulses: when the optical pulse is reflected by a corresponding reflecting device of the two reflecting devices, two orthogonal polarization states of the optical pulse are reflected with an orthogonal rotation of polarization, so that each orthogonal polarization state of the optical pulse, after being reflected by the corresponding reflecting device, is transformed to a polarization state orthogonal thereto.

According to a possible configuration, the reflecting devices 203 and 204 are reflecting devices with an orthogonal rotation of circular polarization. For example, each of the reflecting devices 203 and 204 comprises a reflecting mirror. In this case, the beam splitter 201 may be a circular polarization maintaining beam splitter.

According to another possible configuration, the reflecting devices 203 and 204 are reflecting devices with an orthogonal rotation of linear polarization. For example, each of the reflecting devices 203 and 204 comprises a reflecting mirror and a quarter-wave plate, and the reflecting mirror is integrally formed with the quarter-wave plate at a rear end of the quarter-wave plate, wherein the quarter-wave plate is constructed so that an included angle between a polarization direction of one of the two orthogonal polarization states of each of the two optical pulses and a fast axis or a slow axis of the quarter-wave plate is 45 degrees. In this case, the beam splitter 201 may be a linear polarization maintaining beam splitter.

According to yet another possible configuration, the reflecting devices 203 and 204 are reflecting devices with an orthogonal rotation of elliptical polarization, and the beam splitter 201 may be an elliptical polarization maintaining beam splitter. In this case, suitable reflecting devices may be selected based on a specific elliptical polarization maintaining beam splitter.

For the above several configurations, advantageously, the two optical paths may be configured as polarization maintaining optical paths, and the optical devices on the two optical paths may be configured as polarization maintaining optical devices and/or non-birefringent optical devices. In this way, for each of the two optical pulses obtained by beam splitting: the two orthogonal polarization states of the optical pulse may be kept unchanged during the beam splitting by the beam splitter to reflecting by the corresponding reflecting device, and kept unchanged during the reflecting by the corresponding reflecting device to the beam combining by the beam splitter.

The phase decoding apparatus of FIG. 2 forms a Michelson interferometer with unequal arms, which may be a polarization maintaining Michelson interferometer with unequal arms or a non-polarization maintaining Michelson interferometer with unequal arms, depending on a specific configuration.

Although not shown, the phase decoding apparatus of FIG. 2 may further comprise an optical circulator. The optical circulator may be located at a front end of the beam splitter 201. One incident input optical pulse of an arbitrary polarization state may be input from a first port of the optical circulator and output from a second port of the optical circulator to the beam splitter 201, and the combined output from the beam splitter 201 is input to the second port of the optical circulator and output from a third port of the optical circulator. In this case, an input port and one of output ports of the Michelson interferometer with unequal arms of FIG. 2 are the same port.

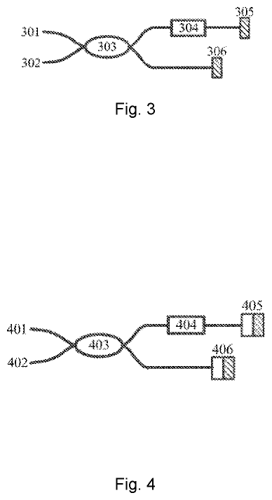

A phase decoding apparatus for quantum key distribution based on reflection with an orthogonal rotation of polarization of another preferred embodiment of the present invention is as shown in FIG. 3, and comprises the following components: a polarization maintaining beam splitter 303, a phase modulator 304, and reflecting mirrors 305 and 306.

The polarization maintaining beam splitter 303 is a circular polarization maintaining optical fiber beam splitter.

One of two ports 301 and 302 on one side of the polarization maintaining beam splitter 303 is used as an input port of the phase decoding apparatus. The polarization maintaining beam splitter 303 and reflecting mirrors 305 and 306 form a polarization maintaining Michelson interferometer with unequal arms, and two optical paths between them are polarization maintaining optical fiber optical paths. The phase modulator 304 is inserted into either of two arms of the polarization maintaining Michelson interferometer with unequal arms. The port 301 or 302 of the polarization maintaining beam splitter 303 is used as an output port of the apparatus.

During operation, an optical pulse enters the polarization maintaining beam splitter 303 via the port 301 or 302 of the polarization maintaining beam splitter 303 and is split into two optical pulses by the polarization maintaining beam splitter 303. One optical pulse from the polarization maintaining beam splitter 303, after undergoing a phase modulation performed by the phase modulator 304, is reflected back by the reflecting mirror 305, and another optical pulse is directly transmitted to the reflecting mirror 306 via a polarization maintaining optical fiber and reflected back by the reflecting mirror 306. The two optical pulses with a relative time delay applied thereto that are reflected back are combined by the polarization maintaining beam splitter 303 and then output via the port 301 or 302.

In the case where the input port and one of output ports of the polarization maintaining beam splitter 303 are the same port, the apparatus may further comprise an optical circulator. The optical circulator may be located at a front end of the polarization maintaining beam splitter 303. One incident input optical pulse of an arbitrary polarization state may be input from a first port of the optical circulator and output from a second port of the optical circulator to the polarization maintaining beam splitter 303, and the combined output from the polarization maintaining beam splitter 303 is input to the second port of the optical circulator and output from a third port of the optical circulator.

A phase decoding apparatus for quantum key distribution based on reflection with an orthogonal rotation of polarization of another preferred embodiment of the present invention is as shown in FIG. 4, and comprises the following components: a polarization maintaining beam splitter 403, a phase modulator 404, and reflecting mirrors with a quarter-wave plate 405 and 406.

The polarization maintaining beam splitter 403 is a linear polarization maintaining optical fiber beam splitter.

The reflecting mirrors with a quarter-wave plate 405 and 406 may be realized by plating a reflecting mirror on a crystal surface of a quarter-wave plate, or by plating a reflecting mirror on an end surface of a polarization maintaining optical fiber with a 90-degree difference in phase of transmission between fast and slow axes. An included angle between a fast axis or a slow axis of the polarization maintaining optical fiber connected to the reflecting mirror with a quarter-wave plate 405 or 406 and a fast axis or a slow axis of the corresponding quarter-wave plate is 45 degrees.

One of two ports 401 and 402 on one side of the polarization maintaining beam splitter 403 is used as an input port of the phase decoding apparatus. The polarization maintaining beam splitter 403 and the reflecting mirrors with a quarter-wave plate 405 and 406 form a polarization maintaining Michelson interferometer with unequal arms, and two optical paths between them are polarization maintaining optical fiber optical paths. The phase modulator 404 is inserted into either of two arms of the polarization maintaining Michelson interferometer with unequal arms. The port 401 or 402 of the polarization maintaining beam splitter 403 is used as an output port of the apparatus.

During operation, an optical pulse enters the polarization maintaining beam splitter 403 via the port 401 or 402 of the polarization maintaining beam splitter 403 and is split into two optical pulses by the polarization maintaining beam splitter 403. One optical pulse from the polarization maintaining beam splitter 403, after undergoing a phase modulation performed by the phase modulator 404, is reflected back by the reflecting mirror with a quarter-wave plate 405, and another optical pulse is directly transmitted to the reflecting mirror with a quarter-wave plate 406 via a polarization maintaining optical fiber and reflected back by the reflecting mirror with a quarter-wave plate 406. The two optical pulses with a relative time delay applied thereto that are reflected back are combined by the polarization maintaining beam splitter 403 and then output via the port 401 or 402.

In the case where the input port and one of output ports of the polarization maintaining beam splitter 403 are the same port, the apparatus may further comprise an optical circulator. The optical circulator may be located at a front end of the polarization maintaining beam splitter 403. One incident input optical pulse of an arbitrary polarization state may be input from a first port of the optical circulator and output from a second port of the optical circulator to the polarization maintaining beam splitter 403, and the combined output from the polarization maintaining beam splitter 403 is input to the second port of the optical circulator and output from a third port of the optical circulator.

Herein, the terms “beam splitter” and “beam combiner” may be used interchangeably, and a beam splitter may also be referred to as and used as a beam combiner, and vice versa. Herein, a “polarization maintaining optical fiber optical path” refers to an optical path that uses a polarization maintaining optical fiber to transmit an optical pulse or an optical path formed by connecting polarization maintaining optical fibers.

The phase decoding apparatus for quantum key distribution based on reflection with an orthogonal rotation of polarization of the present invention may be configured at a receiving end of a quantum key distribution system for phase decoding. In addition, the phase decoding apparatus for quantum key distribution based on reflection with an orthogonal rotation of polarization of the present invention may also be configured at a transmitting end of the quantum key distribution system for phase encoding.

Through the description of the specific embodiments, it should be possible to have a more in-depth and concrete understanding of the technical means adopted by the present invention to achieve the intended purpose and the effects thereof; however, the appended drawings are provided only for reference and explanation, and are not for limiting the present invention.

1. A phase decoding method for quantum key distribution based on reflection with an orthogonal rotation of polarization, wherein the method comprises:
splitting one input optical pulse of an arbitrary polarization state into two optical pulses by a beam splitter; and
transmitting the two optical pulses respectively along two optical paths, with a relative time delay applied to the two optical pulses, and then reflecting them back to the beam splitter respectively by two reflecting devices to be combined and output by the beam splitter;
wherein a phase modulation is performed on at least one of the two optical pulses according to a quantum key distribution protocol in a process of beam splitting by the beam splitter to beam combining by the beam splitter, and
wherein for each of the two optical pulses:
when the optical pulse is reflected by a corresponding reflecting device of the two reflecting devices, two orthogonal polarization states of the optical pulse are reflected with an orthogonal rotation of polarization, so that each orthogonal polarization state of the optical pulse, after being reflected by the corresponding reflecting device, is transformed to a polarization state orthogonal thereto.

2. The phase decoding method for quantum key distribution based on reflection with an orthogonal rotation of polarization according to claim 1, wherein the two reflecting devices are reflecting devices with an orthogonal rotation of circular polarization, and each of the two reflecting devices comprises a reflecting mirror.

3. The phase decoding method for quantum key distribution based on reflection with an orthogonal rotation of polarization according to claim 2, wherein the beam splitter is a circular polarization maintaining beam splitter.

4. The phase decoding method for quantum key distribution based on reflection with an orthogonal rotation of polarization according to claim 1, wherein the two reflecting devices are reflecting devices with an orthogonal rotation of linear polarization.

5. The phase decoding method for quantum key distribution based on reflection with an orthogonal rotation of polarization according to claim 4, wherein each of the two reflecting devices comprises a reflecting mirror and a quarter-wave plate, and the reflecting mirror is integrally formed with the quarter-wave plate at a rear end of the quarter-wave plate, wherein an included angle between a polarization direction of one of the two orthogonal polarization states of each of the two optical pulses and a slow axis of the quarter-wave plate is 45 degrees.

6. The phase decoding method for quantum key distribution based on reflection with an orthogonal rotation of polarization according to claim 4, wherein the beam splitter is a linear polarization maintaining beam splitter.

7. The phase decoding method for quantum key distribution based on reflection with an orthogonal rotation of polarization according to claim 1, wherein the two reflecting devices are reflecting devices with an orthogonal rotation of elliptical polarization.

8. The phase decoding method for quantum key distribution based on reflection with an orthogonal rotation of polarization according to claim 7, wherein the beam splitter is an elliptical polarization maintaining beam splitter.

9. The phase decoding method for quantum key distribution based on reflection with an orthogonal rotation of polarization according to claim 1, wherein for each of the two optical pulses:
the two orthogonal polarization states of the optical pulse are kept unchanged during the beam splitting by the beam splitter to reflecting by the corresponding reflecting device, and kept unchanged during the reflecting by the corresponding reflecting device to the beam combining by the beam splitter.

10. A phase decoding apparatus for quantum key distribution based on reflection with an orthogonal rotation of polarization, wherein the phase decoding apparatus comprises: a beam splitter, two reflecting devices, and two optical paths that are optically coupled with the beam splitter and respectively optically coupled with the two reflecting devices, wherein there is a phase modulator on at least one of the two optical paths,
the beam splitter being used for splitting one input optical pulse of an arbitrary polarization state into two optical pulses;
the two optical paths being used for respectively transmitting the two optical pulses, and being used for realizing a relative time delay of the two optical pulses;
the two reflecting devices being used for respectively reflecting the two optical pulses transmitted by the two optical paths from the beam splitter back to the beam splitter to be combined and output by the beam splitter; and
the phase modulator being used for performing a phase modulation on an optical pulse transmitted by an optical path on which it is located according to a quantum key distribution protocol,
wherein the two reflecting devices are structured so that, for each of the two optical pulses:
when the optical pulse is reflected by a corresponding reflecting device of the two reflecting devices, two orthogonal polarization states of the optical pulse are reflected with an orthogonal rotation of polarization, so that each orthogonal polarization state of the optical pulse, after being reflected by the corresponding reflecting device, is transformed to a polarization state orthogonal thereto.

11. The phase decoding apparatus for quantum key distribution based on reflection with an orthogonal rotation of polarization according to claim 10, wherein the two reflecting devices are reflecting devices with an orthogonal rotation of circular polarization, and each of the two reflecting devices comprises a reflecting mirror.

12. The phase decoding apparatus for quantum key distribution based on reflection with an orthogonal rotation of polarization according to claim 11, wherein the beam splitter is a circular polarization maintaining beam splitter.

13. The phase decoding apparatus for quantum key distribution based on reflection with an orthogonal rotation of polarization according to claim 10, wherein the two reflecting devices are reflecting devices with an orthogonal rotation of linear polarization.

14. The phase decoding apparatus for quantum key distribution based on reflection with an orthogonal rotation of polarization according to claim 13, wherein each of the two reflecting devices comprises a reflecting mirror and a quarter-wave plate, and the reflecting mirror is integrally formed with the quarter-wave plate at a rear end of the quarter-wave plate, wherein the quarter-wave plate is structured so that an included angle between a polarization direction of one of the two orthogonal polarization states of each of the two optical pulses and a slow axis of the quarter-wave plate is 45 degrees.

15. The phase decoding apparatus for quantum key distribution based on reflection with an orthogonal rotation of polarization according to claim 13, wherein the beam splitter is a linear polarization maintaining beam splitter.

16. The phase decoding apparatus for quantum key distribution based on reflection with an orthogonal rotation of polarization according to claim 10, wherein the two reflecting devices are reflecting devices with an orthogonal rotation of elliptical polarization.

17. The phase decoding apparatus for quantum key distribution based on reflection with an orthogonal rotation of polarization according to claim 16, wherein the beam splitter is an elliptical polarization maintaining beam splitter.

18. The phase decoding apparatus for quantum key distribution based on reflection with an orthogonal rotation of polarization according to claim 10, wherein the two optical paths are polarization maintaining optical paths.

19. A quantum key distribution system, comprising:
the phase decoding apparatus for quantum key distribution based on reflection with an orthogonal rotation of polarization according to claim 10, provided on a receiving end of the quantum key distribution system for phase decoding.
